(19) United States
(12) Patent Application Publication
(10) Pub. No.: US 2005/0004841 A1
(43) Pub. Date: Jan. 6, 2005

(54) Systems, methods, and apparatus for facilitating solicitations

(76) Inventors: Jeffrey Weiss, Potomac, MD (US); Gerson Panitch, Potomac, MD (US)

Correspondence Address: WEISS & MOY PC, 4204 NORTH BROWN AVENUE, SCOTTSDALE, AZ, 85251, US

(21) Appl. No.: 10/882,436

(22) Filed: Jul. 1, 2004

Related U.S. Application Data
(60) Provisional application No. 60/484,867, filed on Jul. 3, 2003.

(51) Int. Cl. G06F 17/60

(52) U.S. Cl. 705/14

(57) ABSTRACT

A telephone solicitation method based on agreement between a telephone solicitor and a telephone owner, to provide telephone solicitations for consideration. The consideration can be in the form of free or reduced cost telephone service. The phone service can be a land line, wireless service, or Internet access.

### RELATED APPLICATION

This non-provisional application claims priority from provisional application No. 60/484,867, filed on Jul. 3, 2003.

### FIELD OF THE INVENTION

This invention relates generally to systems, methods, and apparatus for facilitating solicitations using, for example, a telecommunications system. Aspects of the invention may relate, for example, to a method for providing telephone solicitations to a telephone user in an agreed manner in exchange for a form of consideration.

### BACKGROUND OF THE INVENTION

In today's environment, it is increasingly difficult for telemarketing entities, or those entities that the public often associates with telemarketers (such as for example market research or polling entities) to be able to successfully communicate with willing listeners. For example, caller identification and the like have given phone owners the ability to determine that an incoming phone call is or at least possibly is originating from such an entity, and to avoid answering such a call. There are also legislative efforts to limit the ability of telemarketing entities and the like to freely call phone owners, by, for example, limiting the hours during which such calls can be made, or to give phone owners certain “do not call” rights. These developments have been harmful to such phone solicitation entities.

A method that would permit the placement of phone solicitation calls to willing listeners, in exchange for appropriate consideration, would benefit all concerned. From the point of view of the phone solicitation entity, the nature and quality of the telephone interaction would dramatically change if the call recipient had agreed in advance to accept the call, and indeed if the recipient were being provided consideration for accepting such call. In such instance, the telephone solicitor would not need to engage in an aggressive pitch that is designed to keep the call recipient from hanging up. And, because the call recipient would be a willing actor, the actual communication would be likely to be more pleasant and more productive. From the point of view of the call recipient, the knowledge that receipt of the call has been agreed to and is the subject of consideration will make the call far less objectionable.

### SUMMARY OF A FEW ASPECTS OF THE INVENTION

One aspect of the invention may involve a method for presenting telephone solicitations to a phone owner, pursuant to an agreement in advance between a telephone solicitor or solicitor's mediator and the phone owner.

Another aspect of the invention may involve telephone solicitations to a phone owner, at an agreed time of day or relating to an agreed upon subject matter.

Another aspect of the present invention may involve providing telephone solicitations to a telephone owner for consideration in the form of an incentive.

Yet another aspect of the present invention may involve a method for presenting telephone solicitations to a telephone owner in return for an incentive in the form of free or reduced cost telephone service.

The invention may further involve a system and method whereby a mediator obtains the consent of network system users to accept commercial communications in return for at least one incentive. The mediator might then facilitate a commercial communication initiated by a commercial venture, and then collect remuneration from the commercial venture.

Incentives received by users might vary depending on the magnitude/duration of commercial communications accepted by the user.

The system might also include a verification mechanism so that the user may verify in advance that the commercial communication falls within the terms of an agreement with the mediator. In addition, a point system may be used to provide the user with credit for receiving the commercial communication.

The foregoing are only a few examples of aspects of the invention for exemplary purposes only, and are not intended to limit the scope of the invention described in further detail herein.

### BRIEF DESCRIPTION OF THE DRAWINGS

FIG. 1 is a flow diagram, illustrating a method for providing telecommunications services, consistent with an embodiment of the present invention.

FIG. 2 is a block diagram of a telecommunications system consistent with an embodiment of the present invention.

### DETAILED DESCRIPTION OF THE PREFERRED EMBODIMENTS

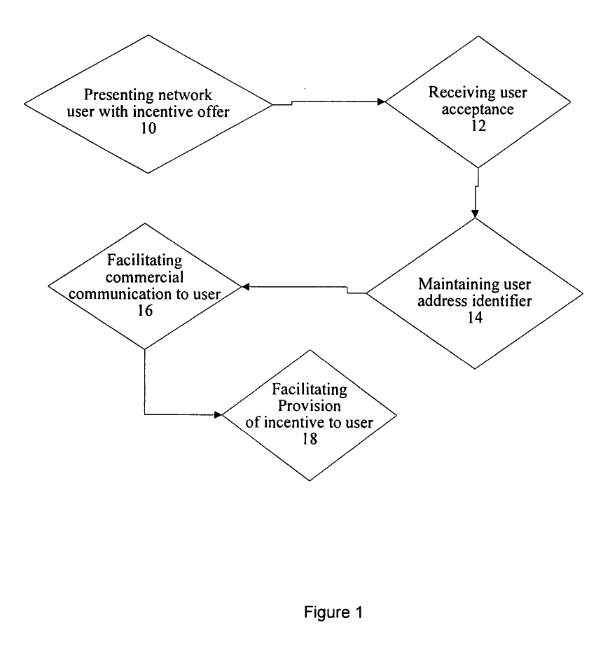

Consistent with the invention, and as depicted with reference numeral 10 in FIG. 1, there may be provided a telecommunication method that includes presenting to a user of a telecommunications network an offer to receive at least one incentive in return for accepting at least one commercial communication over the telecommunications network. As embodied herein, the term “user” broadly includes one or more of an individual, a household, or other groups of individuals, at least one of whom is an actual or prospective account holder or other user on a telecommunications network. “Telecommunications network” as used herein includes wired networks, wireless networks, combinations of wired and wireless networks, and any other network for facilitating communications between at least two entities.

In accordance with one aspect of the invention, a user may be provided with at least one incentive offer. The incentive offer may include any item, service, credit or discount that has actual or perceived value to the user. Non-limiting examples of incentives include money, credits, gift certificates, merchandise, product samples, coupons, electronics, communications devices (such as a telephone) for use on the telecommunications network, redeemable points, frequent flyer miles, reduced fee telecommunications services, free telecommunications services, or any other article, currency, benefit or service.

An offer to receive an incentive might occur through printed advertisement, television advertisement, radio advertisement, direct mail advertising, internet advertisement, face to face communication, a telecommunications device, or any other print, broadcast, or telecommunications mechanism that may be employed to interest the user in receiving the incentive.

With the popularity of the U.S. government's do-not-call list growing, the offer might extend to the user an opportunity to receive the incentive in return for the user's acquiescence to receive a commercial communication despite the user's inclusion on a do-not-call list.

In return for the incentive the user might agree to accept one or more commercial communications via the user's telecommunications device. By way of example, if the telecommunications device is a wired phone in the user's residence, or the user's wireless phone, Blackberry, or PDA, the user might agree to accept a number of commercial communications in return for the incentive. “Commercial communications” as used herein broadly refers to any type of solicitation, advertisement, offer, or other informational conveyance to the user, regardless of whether the communication has a profit or not for profit motive.

As depicted by reference numeral 12 in FIG. 1, a method according to the invention may also include receiving an acceptance of the offer from the user. As embodied herein, the acceptance may be received in oral or written form using mechanisms such as hard copy, interactive voice response (IVR) systems, internet web sites, etc. The acceptance may take the form of an application, and might contain an acknowledgment by the user of an established business relationship between the user and the offeror. Such a recorded acknowledgment might provide the offeror with a protection against a user who later claims that a commercial communication violated a government restriction on telephone solicitations, such as the U.S. government's do-not-call list.

Whether the acceptance is received in hard copy, through IVR, internet, telecommunications device, or otherwise, a record of the accepting user's address associated with a telecommunication device may be recorded. Other information about the user could also be recorded. For example, a record might be kept detailing the date and form of the acceptance. A record might be kept of demographic information about the user. For example, profession, hobbies, purchasing habits, marital status, age, income level, preferred types of solicitations etc. might be useful in matching a commercial communication with the user.

As depicted by reference numeral 14 in FIG. 1, the invention may further involve maintaining a record of an address associated with a telecommunications device of a user. The address may include, for example, a telephone number, an e-mail address, an IP address, or any other information that enables contact with the user through a telecommunications device.

The invention may further involve enabling access to the address in order to facilitate the placement of a commercial communication to the user through the telecommunication device. As used herein, the term “enabling access” broadly includes providing sufficient information to a commercial venture to enable the communication to be made with the user. In a situation where the same entity that received the user's acceptance is making the commercial communication with the user, enabling access may simply involve providing a human telemarketer (or machine telemarketer) to have access to the user's address (e.g., telephone number) .

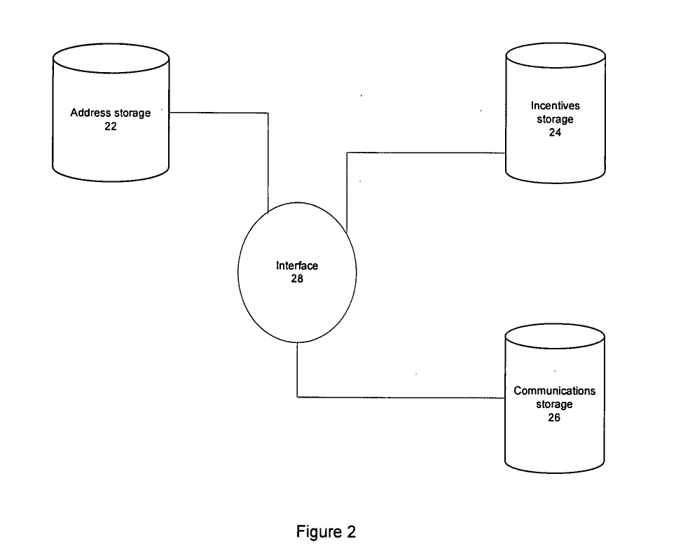

In an alternative embodiment, the offeror and the commercial venture may not be the same entity. For example, the offeror may be affiliated with a telemarketing type company that signs up users, and thereafter makes the user's addresses (e.g., phone numbers) accessible to commercial ventures in return for a fee or other remuneration. In this instance it may be beneficial to route the commercial venture's communication with user's through a mediator's telecommunications system. Such a structure may enable control over user information, permitting the number of contacts with any one user to be carefully monitored and restricted. For example, the terms of an agreement with a user might be that the user is to receive no more than 10 commercial communications per month. By routing the calls through a mediator's system, the mediator may insure that the terms of an agreement or a policy are adhered to. Such a system might track the duration of the connection to ensure that the user did not terminate the communication before its intended conclusion. If so, the user might not receive full credit, or may only receive partial credit for receiving the communication. FIG. 2 is an exemplary block diagram of an embodiment of a telecommunications system consistent with the invention. For example, an address storage component 22 (e.g., server or other storage media) might store user telecommunications addresses; an incentive storage component 24 might store information reflective of incentives accruing and/or provided to a user; a communications component 26 might track information relating to aspects of communications with users and user preferences; and an interface 28 might facilitate interaction between the components 22, 24, and 26. Interface 28 permits the mediator or other actor to keep track of incentives provided to individuals associated with stored telecommunications addresses who have agreed to receive commercial communications.

It is important to note the exemplary nature of FIG. 2. For example, the functions of the various components 22, 24, 26, and 28 may be consolidated in a single component or further divided into additional components. In addition, a single computer system or multiple computer systems may be programmed to carry out system functionality described above with reference to FIG. 2, without departing from the scope or spirit of the invention.

The invention might also provide for verification, so that the user does not receive unauthorized commercial communications. For example, if all calls are routed through the mediator's telecommunications system, a caller ID feature on the user's phone might verify the source of the call. Alternatively, a preselected code or other identifier know in advance to the user, might be audibly or visually transmitted at an early stage of the commercial communication so that the user might verify that the communication is authorized.

To facilitate acceptance of communications, points might be awarded to the user based on one or more of a host of factors, including but not limited to: number of calls received, duration of calls received, demographic match between the user and the commercial communication; amount paid by the commercial venture, etc. In this way, the user might accumulate redeemable points. The user might be advised at the beginning of the call of the number of point associated with the call.

If the user fails to comply with terms of the offer, incentive may be withdrawn or limited.

In one example, a user is provided with free wireless phone service in return for accepting a certain quota of commercial communications each month. If the user avoids accepting a sufficient number of calls to reach that quota, the user might then be billed for some or all of the wireless phone service.

So, for example, in the embodiment of FIG. 1, steps 10 and 12 may reflect an agreement reached between a telecommunication solicitation entity and a telecommunication device owner. (It should be noted that the telecommunication solicitation entity could literally be the same entity that will engage in telecommunications solicitations. Optionally, it could be an agent or other third party acting on behalf of, or pursuant to a contract with, a telecommunication solicitation entity.)

The agreement will be for the owner to receive telecommunication solicitations from the telecommunication solicitation entity for consideration. The appropriate form of the consideration to be provided to a telecommunication device owner in exchange for the owner's agreement to receive solicitations can be varied as desired. For example, the consideration may be related to the cost of the telephone service for the phone number that is the subject of the solicitation. For example, the consideration can be that a person will receive free telephone service (either wireless or a land line) in exchange for the person's agreement to participate in an agreed number of telephone solicitations over an agreed period of time. Thus, an agreement might provide that for every month of telephone service provided, the phone holder agrees to receive a specified number of telephone solicitations (e.g., 5 calls per month). Alternatively, the phone holder can agreed to participate in telephone solicitations for an agreed duration (e.g., 10 minutes of calls per month), without regard to the number of solicitations made, in exchange for phone service.

As an alternative, the agreement could provide that the cost of phone service will be reduced by an agreed amount for every solicitation received, and/or for every unit of time (e.g., minute) during which a phone holder participates in a telephone solicitation. For example, each solicitation could reduce the cost of phone service by one dollar, or any other desired amount.

Still further, as an inducement for a phone owner to make a purchase in response to a solicitation, the completion of a purchase can be given one of several possible effects. For example, the making of a purchase can eliminate the requirement to receive other solicitation calls. In this example, a purchase in the month of June may eliminate the need for further solicitation calls during that month, for that month and the next month, etc. As an added alternative, the extent to which participation can be excused can be triggered to the amount spent on the purchase, with a higher purchase amount forgiving a greater volume of calls.

As depicted, for example, by reference numeral 16 in FIG. 1, the invention may include facilitating the placement of a commercial communication to the user through the telecommunications device. The commercial communication, for example, may take the form of a solicitation or an advertisement. The solicitation or advertisement may be delivered by a live telemarketing professional, or by a recording. To ensure that a phone owner is actually listening to a solicitation, particularly where it is recorded, it may be desired to prompt the owner with a requirement to depress a key on the telephone keypad, to recite a word, or otherwise to demonstrate his or her presence on the line.

In addition, the solicitation may be displayable on a telephone screen. In this embodiment, the advertisement can be in the form of a pop-up type of advertisement. The advertisement can be static or can have movement.

Preferably, there will be other aspects to the agreement between the phone owner and the solicitation entity. For example, the phone owner can request that phone solicitations be received during designated times of the day. Relatedly, since the phone owner has made a commitment to participate in telephone solicitations, provision can be made for the phone owner to initiate contact with a telemarketing entity. For convenience, in this embodiment, it will likely be desired to provide a single number to be called by the phone owner, with the telemarketing service to make provision for routing the call to the appropriate person. If the phone is one that is provided as an incentive, the phone may contain a speed dial button, appropriately marked, that enables the user to quickly initiate a commercial communication. In this way the user can accept commercial communications when the user has free time, and may thereby avoid calls at times that are inconvenient. To this end, the system may be programmed not to place a commercial call to a user who has self initiated a contact within a preceding proscribed period. For example, rule might be set up so that if the caller has already completed a monthly quota, or is ahead of schedule to complete a quota, no calls will be placed to the user. Or, if the user has initiated a call within the prior 48 hrs, no calls will be placed to the user. As mentioned earlier, points might be awarded based on participation. To avoid misuse, the system might periodically prompt the user to provide a response, thereby confirming that the user is listening and has not simply set the phone aside.

It may also be desired for the phone owner to be able to designate the subject matter of solicitations which he or she is interested in receiving. For example, a person may wish to only receive solicitations concerning travel, magazine subscriptions, home improvement, political polling, etc.

Where an owner can express his or her preferences, for example with respect to the time of calls and/or their subject matter, it will be desired to provide a convenient mechanism for doing so. For example, a web-site can be provided, where an owner can go to review information concerning his or her options, and select (and/or change) desired options. Optionally, an owner can call into to a central number, where preferences can be supplied.

It is preferred that the agreement relating to consideration and the like should be achieved prior to the initiation of the telephone solicitation, for which consideration is to be provided.

It should be noted that the term “telecommunications network” or “telecommunications” referred to herein broadly include land line phone service; wireless telephone service; Internet-access, whether provided over a telephone line or a cable; and wireless transmission to mobile phones, PDA's and other information receiving devices. Where the service is Internet service, it should be noted that the solicitations could be in the form of e-mail advertisements, as well as pop-up or other types of advertisements, or other visual based services that are communicated to a device accessing the Internet or other network.

According to another aspect of the invention, generally depicted by reference numeral 16 in FIG. 1, the invention may include facilitating the provision of an incentive to the user. Users might be provided with a free phone and/or free phone service in exchange for accepting commercial communications, such as solicitations on that phone. Alternatively, users might receive another incentive or credit towards an incentive, as described earlier. The user might be capable of predesignating block out times during the day when commercial communications will not be initiated. Alternatively (or in addition) the user might be permitted to predesignate times during the day for receipt of such commercial communications. Predesignations might occur orally to a representative, through IVR, over the internet, using menus or response systems directly through the telephone on which the commercial communications are made, or in any other manner of communication. In the same (or different) manner, a user might also be able to select preferences for the types of commercial communications to be received.

Additional examples of incentives include entering participants in a lottery for periodic drawings of cash or other items of value. The chances of success might be a function of the magnitude of commercial communications received by the user either in terms of numbers, total duration, a point scale, or any other mechanism. If for example, a large cash reward is awarded on a regular basis, publicity surrounding it might motivate others to participate or might boost participation by existing users.

While the invention has been particularly shown and described with reference to preferred embodiments thereof, it will be understood by those skilled in the art that the foregoing and other changes in form and details may be made therein without departing from the spirit and scope of the invention.

1. A telecommunication method, comprising:
presenting to a user of a telecommunications network an offer to receive at least one incentive in return for accepting at least one commercial communication over the telecommunications network;
receiving an acceptance of the offer from the user;
maintaining a record of an address associated with a telecommunication device of the user;
enabling access to the address in order to facilitate the placement of a commercial communication to the user through the telecommunication device; and
facilitating a provision of the incentive to the user.

2. The method of claim 1, wherein enabling access includes mediating a communication between a commercial venture and the user, the method further including collecting remuneration from the commercial venture in return for the mediating.

3. The method of claim 1, further comprising withdrawing at least a portion of the incentive if the user refuses to receive the at least one commercial communication.

4. The method of claim 1, wherein the offer extends to the user an opportunity to receive the incentive in return for the user's acquiescence to receive a commercial communication despite the user's inclusion on a do-not-call list.

5. The method of claim 1, wherein the incentive includes at least one of free telephone service and telephone service at a discounted rate.

6. The method of claim 1, wherein the commercial communication is at least one of a solicitation and an advertisement.

7. The method of claim 1, further including receiving from the user an acceptance of the offer, wherein the acceptance is in the form of at least one of an application and an acknowledgment of an established business relationship.

8. The method of claim 1 wherein said telecommunication service is at least one of wireless telephone service and a wired telephone service.

9. The method of claim 1, further comprising storing a verification code recognizable to the user so that the user can confirm a legitimacy of the commercial communication.

10. The method of claim 1, wherein a magnitude of the incentive is at least in part a function of a number of commercial communications accepted by the user.

11. The method of claim 1, wherein a magnitude of the incentive is at least in part a function of a total duration of commercial communications received by the user.

12. The method of claim 6 wherein an amount of the at least one commercial communication that is to be facilitated to the user shall be reduced as a result of the user making a purchase as a result of a commercial communication.

13. The method of claim 1, further comprising assigning point values to commercial communications, and wherein a magnitude of the incentive is at least in part a function of a user's accumulated point values.

14. The method of claim 1, further comprising enabling the user to be advised in advance of receipt of a commercial communication, a point value associated with the commercial communication.

15. The method of claim 1, wherein the telecommunication device is a wireless telecommunications device, and wherein the incentive includes providing the user with at with the wireless telecommunications device at least one of a discounted price and free of charge.

16. The method of claim 1 further comprising the step of receiving from the user a selection of at least one preferred time period to receive the at least one commercial communication.

17. The method of claim 1 further comprising the step of receiving from the user a selection of at least one preferred subject matter for the at least one commercial communication.

18. A telecommunication method, comprising:
presenting to a user of a telecommunications network an offer to receive at least one incentive in return for initiating at least one commercial communication over the telecommunications network;
receiving an acceptance of the offer from the user;
maintaining a record of an address associated with a telecommunication device of the user;
facilitating the placement of a commercial communication from the user through the telecommunication device; and
facilitating a provision of the incentive to the user.

19. A telecommunications system, comprising:
an address storage component for storing telecommunications addresses of individuals who have accepted offers to receive at least one incentive in return for acceptance of at least one commercial communication over a telecommunications network;
an interface for accessing the address storage component to enable contact of at least some of the individuals using the stored addresses;
an incentives storage component for keeping track of incentives provided to the individuals; and
a communications storage component for keeping track of commercial communications made with individuals.

20. A telecommunication method, comprising:
presenting to a user of a telecommunications network an offer to receive at least one incentive in return for accepting at least one commercial communication over the telecommunications network;
recording, through a mediator, an acceptance of the offer by the at least one user;
recording, through a mediator, a telecommunications device address of the at least one user;
enabling a commercial venture to communicate with the user by providing the commercial venture with access to a telecommunications system controlled by the mediator;
facilitating the commercial communication through the mediator; and
receiving compensation from the commercial venture.

21. The method of claim 20 wherein facilitating includes routing the commercial communication through a telecommunications system controlled by the mediator.
